(19) United States
(12) Patent Application Publication
(10) Pub. No.: US 2005/0178762 A1
(43) Pub. Date: Aug. 18, 2005

(54) Food merchandising system

(75) Inventors: Mark J. Klosterman, St. Louis, MO (US); Randy L. Lines, Lincoln, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Duke Manufacturing Company, St. Louis, MO (US)

(21) Appl. No.: 11/038,932

(22) Filed: Jan. 19, 2005

Related U.S. Application Data
(60) Provisional application No. 60/538,261, filed on Jan. 22, 2004.

(51) Int. Cl. H05B 6/64

(52) U.S. Cl. 219/679

(57) ABSTRACT

A foodservice merchandiser comprising a counter unit having a cabinet with vertical front, rear and end sides and a horizontal upper surface countertop side extending between the upper margins of said vertical sides, the countertop side being constructed and arranged with a primary zone to perform a first food-oriented function, and the cabinet also having a secondary zone constructed and arranged to perform a second food-oriented function, the secondary zone being associated with one of the counter unit sides.

### FIELD OF THE INVENTION

This invention relates generally to improvements in commercial foodservice systems, and particularly to single and multiple counter units for the presentation and merchandising of foods as in cafeteria and buffet lines and food courts.

### BACKGROUND OF THE INVENTION

Foodservice equipment is used in commercial kitchen and dining areas for food preparation, presentation and/or dispensing as in (1) volume-feeding facilities such as restaurants, hotels, institutions, corporate dining rooms and the like, and (2) the service of prepared foods especially in cafeteria and buffet lines, retail food courts and the like.

Such commercial foodservice equipment is traditionally custom designed to perform various specific foodservice functions and each counter unit is usually self-contained, free standing in a fixed location and has a single function. Thus, each counter unit is built onto a supporting base and designed with a countertop compatible with the specified foodservice function. The countertop function dictates to the foodservice provider the types of surface and base configurations as well as utility requirements and other desirable features. In addition, all counters used in preparing or serving food products conform to the rigid sanitation codes of the National Sanitation Foundation (NSF) and, thus, traditionally the use of costly, heavy gauge stainless steel has been mandated.

In prior art foodservice systems, as used in cafeteria line-ups for instance, a series of different function counters are typically rigidly connected together in a continuous line-up. Tuhro U.S. Pat. No. 5,163,536 discloses a rigidly interconnected series of cafeteria counters typical of such past equipment styling direction where a preselected order of foodservice functions is the major objective. Thus, apart from achieving the necessary functional and safety requirements for such commercial equipment, the installation location and maintenance of past foodservice counter units is generally limited to a single style or arrangement of counters as dictated by service function, and peripheral decor display and/or merchandising signage function has been minimal and unsatisfactory. In short, past commercial foodservice counters have been custom made and expensive, the selectivity of counter unit arrangements has been limited, the manufacturing and delivery time has been long, and assembly of equipment line-ups has been difficult and time consuming.

Co-owned U.S. Pat. No. 6,561,317 (Dudley) for Foodservice System and related design Pat. Nos. D457,016; D457,020; D457,361; D457,362; D458,059 and D461,073 disclose foodservice equipment having improvements in the flexibility of counter unit arrangements and the use of peripheral design decor to provide better functionality with unique, high style presentation. However, even though this design direction offers a wider versatility in foodservice equipment layout (as in food courts), the freestanding nature of these counter and peripheral decor units has been found to have some limiting features.

### SUMMARY OF THE INVENTION

The invention is embodied in a food merchandising system, comprising a primary counter unit positioned in a food serving arena and being constructed and arranged to perform at least one direct or related food-oriented function, the primary counter unit having an upper countertop work area with outer end margins; and a peripheral unit constructed and arranged to perform a second food-oriented function, the peripheral unit being constructed and arranged with a side margin or surface at least partially complementary to at least a portion of one outer end margin or surface of the primary counter unit and being juxtaposed proximately therewith to thereby optimize functionality with a minimum footprint in the food serving arena.

A principal object of the present invention is to provide an improved food merchandising system for the preparation, display and/or dispensing of hot, cold or ambient food products in a food serving arena.

Another object of the invention is to provide a food service system that achieves optimum food serving functionality with a minimum footprint occupancy on the floor in the food serving arena of a food consuming facility.

Another object is to provide a counter unit and enhanced peripheral display decor for commercial foodservice systems affording greater design flexibility and upscale decor selectivity.

Another object is to provide a foodservice system with selective placement of primary countertop units with flanking pylon and/or shelving peripherals alone or in combination with an upper canopy peripheral.

Another object is to provide a commercial counter unit that is rugged in construction and economically manufactured, and which permits easy installation in selective floor arrangements with mobility or revision capabilities.

Still another object is to provide novel foodservice equipment offering improved flexibility in decor and product display and superior maintenance accessibility.

These and still other objects and advantages will become more apparent hereinafter.

### BRIEF DESCRIPTION OF THE DRAWINGS

In the accompanying drawings, which form a part of the specification and wherein like numerals refer to like parts wherever they occur:

FIG. 1 is a diagrammatic frontal perspective view illustrating a prior art food service system having multiple counter units and flanking peripheral pylon units;

FIG. 1A is an enlarged partial perspective view of one of the prior art peripheral pylons of FIG. 1;

FIG. 1B shows an alternative pylon design;

FIG. 1C shows another alternative pylon design;

FIG. 2 is a simplified frontal perspective view similar to FIG. 1, showing a multiple counter system embodying the invention;

FIG. 3 is an enlarged front perspective view of a single counter unit from the FIG. 2 embodiment of the invention;

FIG. 4 is a front elevational view of the FIG. 3 single counter unit embodiment;

FIG. 5 is a plan view of the FIG. 3 embodiment;

FIG. 6A is a fragmentary diagrammatic view showing a counter with a unified end-mounted pylon;

FIG. 6B is a view similar to FIG. 6A, but showing a sliding fit between a counter and a mating end pylon;

FIG. 6C is also similar to FIG. 6A and 6B, but showing the pylon in closely-spaced relation to the counter;

FIG. 7A is a fragmentary graphic view showing one position of orienting adjacent counters in a multiple counter system embodiment;

FIGS. 7B and 7C are views similar to FIG. 78 showing relative angular changes of the orientation of adjacent counters in a multiple counter system;

FIGS. 8A, 8B and 8C are views corresponding to FIGS. 7A, 7B and 7C showing the relative angular counter orientation of another embodiment of the invention;

FIG. 9 is a view Similar to FIGS. 7A and 8A, but showing a third embodiment of the invention;

FIG. 10 is an enlarged perspective view of a mobile food display and serving counter unit and associated side or end peripherals embodying the invention;

FIG. 11 is a front elevational view of the FIG. 10 embodiment;

FIG. 12 is a fragmentary plan view taken along line 12-12 of FIG. 11;

FIG. 13 is a view similar to FIG. 12 showing adjacent counter units;

FIG. 14 is a perspective view showing another embodiment of a mobile food display and serving unit and associated side or end peripherals embodying the invention;

FIG. 15 is a front elevational view of the FIG. 14 embodiment including a soffit peripheral;

FIG. 16 is a plan view taken along line 16-16 of FIG. 15;

FIG. 17 is a side elevation of a further modification of the counter end peripherals;

FIG. 18 is a view similar to FIG. 14, partly broken away, and showing a counter adaptation with optional food merchandising units;

FIG. 19 is a plan view of the FIG. 18 embodiment; and

FIG. 20 is a rear elevational view thereof.

### DESCRIPTION OF THE PREFERRED EMBODIMENTS

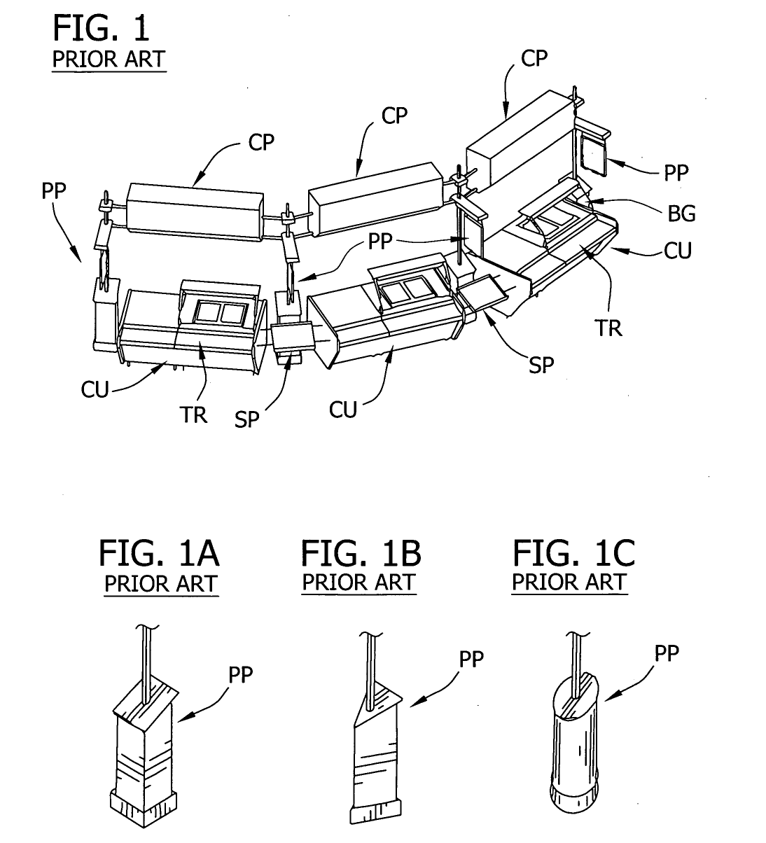

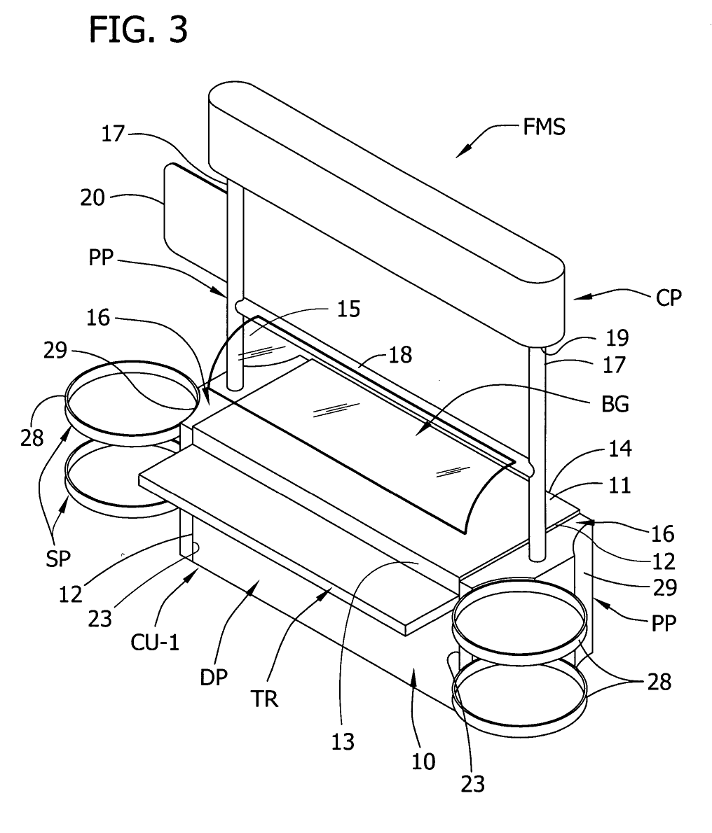

The food merchandising system of the present invention provides improvements over prior foodservice counter and peripheral unit technology developed and marketed by applicants assignor. More specifically, FIG. 1 is a diagrammatic prior art showing corresponding to FIG. 9 of U.S. Pat. No. 6,561,317 and FIG. 3 of U.S. design Pat. No. D458,059; and FIGS. 1A, 1B and 1C are partial showings of different representative pylon base configurations of U.S. design Pat. Nos. D461,0173, D457,362 and D457,020, respectively. The disclosures of these prior art patents is incorporated herein by reference in their entirety.

The present invention provides improvements in primary service counter units CU for the enhanced performance of direct and related food-oriented functions, and incorporates novel peripheral units (defined below) primarily to perform non-foodservice functions as well as selected food-oriented functions and improvements in food delivery and health safety features to be described.

The following descriptions are adopted herein for purposes of disclosing and claiming the invention:

“direct food-oriented function” generically means the use of any primary service counter unit CU or peripheral unit as a work station for preparing, displaying and/or dispensing (i.e. merchandising) any heated, cooled or ambient food product. Such counter units CU are inclusive of steam tables and hot food drop-in units and soup wells; hot food surface and microwave units; bun, pretzel, pizza, nacho chip and cheese warmers and oven units; cold pan and frost top units; deli products, refrigerated and ambient selector cases; salad bar units; hot and cold juice and beverage units, coffee brewers and shuttles; ice and soda dispensers; dessert units and like cafeteria, food court and speciality food units.

“related food-oriented function” generally means the use of a primary counter or peripheral unit for display or dispensing of ancillary food consumption articles or accouterments such as trays, tableware, napkins, condiments, cups and dishes, or the performance of cashier or other services.

“merchandising function” generally means the associated use with a primary counter or peripheral unit of lighting, decor enhancement, advertising display or other signage, such as menu, pricing or services information or directions.

“peripheral(s)” generally means a secondary unit or subsystem associated with a primary counter unit for performing a merchandising or food-oriented function; or a non-foodservice function i.e. decor enhancement, lighting, advertising display or information signage. Peripherals of the present invention include pylon units, canopy units and shelving units (which may have a direct or related food-oriented function).

“non-foodservice function” generically means the performance by a peripheral of a function that is ancillary to the direct or related food-oriented functions of a primary counter unit.

“pylon peripheral” (PP) refers generally to a separate vertical unit laterally and proximately disposed relative to a primary counter unit.

“canopy peripheral” (CP) refers generally to an independent unit in vertical disposition above a primary counter unit. The canopy may also be called a “soffit” or “marquee”.

“shelving peripheral” (SP) refers to a shelving system generally positioned adjacent to the end of a primary counter unit, and sometimes being connected thereto or with a pylon peripheral.

The term “juxtaposed proximate” as used herein is a generic term referring to the extreme or intimate closeness and matching fit between opposing wall segments or surfaces of a counter end and an adjacent pylon peripheral.

Referring again to FIG. 1 (and the FIG. 1A pylon base alternative), the prior art counter and pylon system is best represented as having a series of single counters CU arranged in a spaced apart end-to-end angled (or in-line) arrangement and each having free-standing flanking pylon peripherals PP and an overhead canopy peripheral CP supported thereby. A single pylon peripheral is shared between the spaced ends of adjacent counters CU. Also shelving peripherals SP may span the gap between the opposed adjacent counter ends and are connected thereto independently of the pylon PP. The prior art of FIG. 1 also has a breath guard BG structure connected to the counter top in a typical manner, and a tray rail TR is provided. For disclosure purposes all of the prior art counters CU and peripheral features are alike. With reference to FIGS. 1A, 1B and 1C, it will be seen that the base section of the pylon peripheral PP may have different configurations independently of the end configuration of the counter (CU).

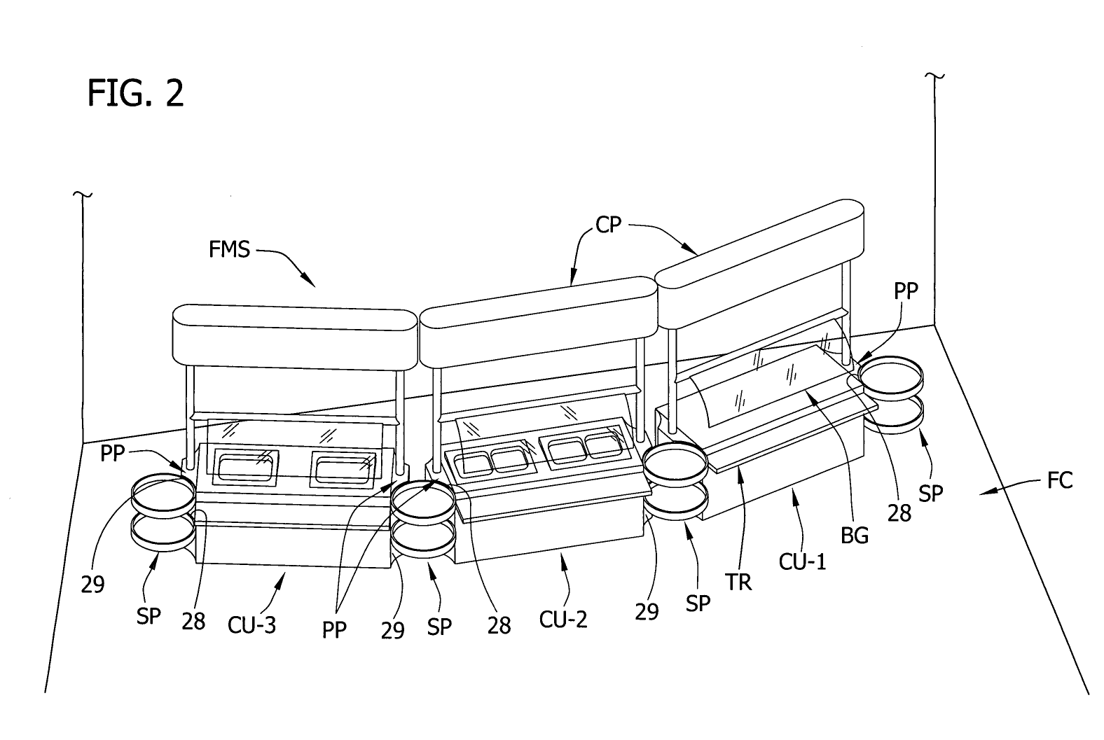

The food merchandising system FMS of the present invention has several features or aspects and may take several forms or arrangements. One embodiment of the present invention is a multiple counter system as disclosed in FIG. 2 for direct comparison with the prior art counter/peripheral unit arrangement shown in FIG. 1. In FIG. 2 a lineup of three primary counter units CU-1, CU-2 and CU-3 are arranged in an arcuate pattern in the food serving arena of a food court (FC) or cafeteria, lunch room or the like. Briefly described, each counter unit (CU) is shown flanked at each end by its own pylon peripheral PP and being spanned overhead by a canopy peripheral CP. Shelving peripherals SP are constructed and arranged for connection to the pylon peripheral PP at the ends of the counters and, in the FIG. 2 embodiment, these shelving peripherals SP may join or connect flanking pylon peripherals PP of adjacent counters to form a unified merchandising system that has a minimum floor space (footprint) occupancy in the food serving arena. In short, the food service equipment of the present invention provides optimum utilization of floor space to maximize food serving functionality therein as well as provide maximum consumer shopping and food consumption areas in a food consumption facility.

To attain the objective of providing optimum functionality with minimum footprint utilization in the food serving arena, the counter units (CU) which perform the direct and related food-oriented function and the adjacent end-flanking pylon peripherals (PP) are constructed and arranged with substantially complementary adjoining marginal edges or surface areas, to be described more fully. In one aspect, the pylon PP may form a unified end cap secured to the outer end wall surface of the counter CU or forming an extension to the upper work area thereof. In another aspect, the pylon peripheral PP may be an independent self-standing unit adjoining the counter in an abutting contiguous relationship so as to appear to be unified or attached thereto. In a further aspect, the pylon peripheral PP may be oriented with the counter end wall so as to have a sliding fit therewith and thereby accommodate a relative linear (non-angular) movability therebetween.

The objective of maximizing food serving functionality with high style decor (and signage) is further met in the present invention by adjoining adjacent counter units (CU) and the respective end-oriented pylons PP thereof with bridging shelving peripherals SP that have marginal edges or sides configured to be complementary to matching pylon surfaces so as to provide a substantially continuous food display and/or service system, as will be further described in more detail. It should be noted that this pylon-shelving relationship may accommodate relative angular counter unit rearrangement while maintaining continuity of food merchandising.

Still referring to FIG. 2, another aspect of the invention that enhances food merchandising service is the optional provision of canopy peripherals CP mounted above the counter units (CU). As will be described more fully, the canopy peripherals CP are constructed and arranged to be supported at each end thereof by the pair of pylon peripherals PP that flank the ends of each counter unit (CU) whereby each counter unit may constitute a separate food serving system with independent lighting, signage, decor and the like while providing the option of counter location substitution or rearrangement through the feature of relative mobility between the counter unit and its adjacent and independent peripheral system. Another feature of the invention, to be described in more detail, is the provision of a breath guard (BG) to shield the food work area of the counter from the consumers front tray rail (TR) position, and which breath guard is mounted on the pylon peripherals PP and may be angularly adjustable thereon and totally independent of the counter unit per se thereby providing an optimum upper work area.

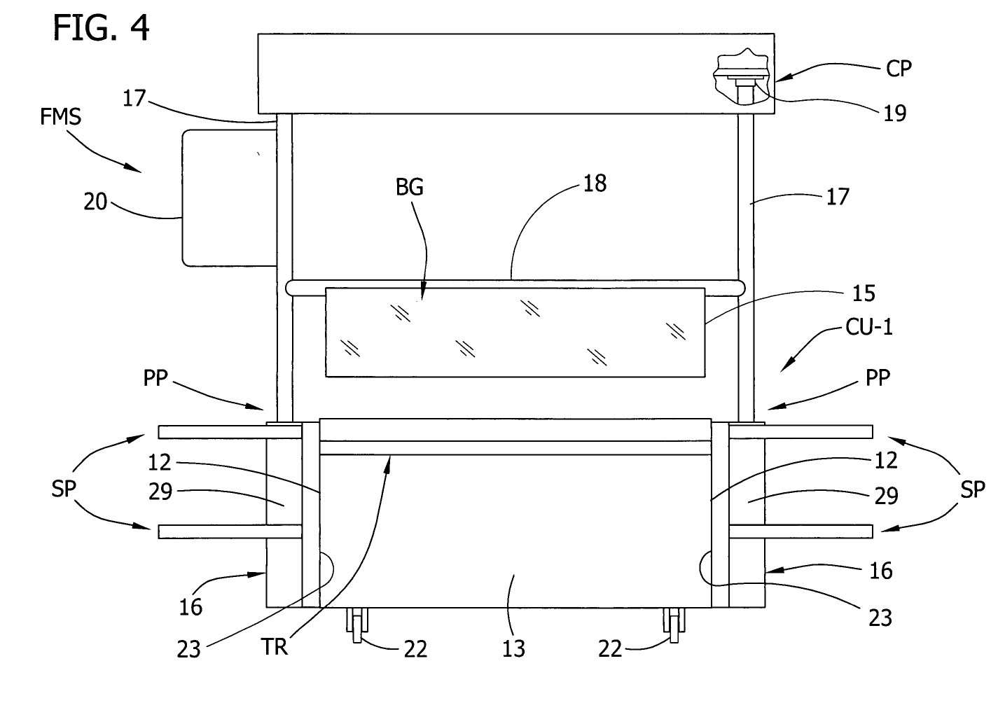

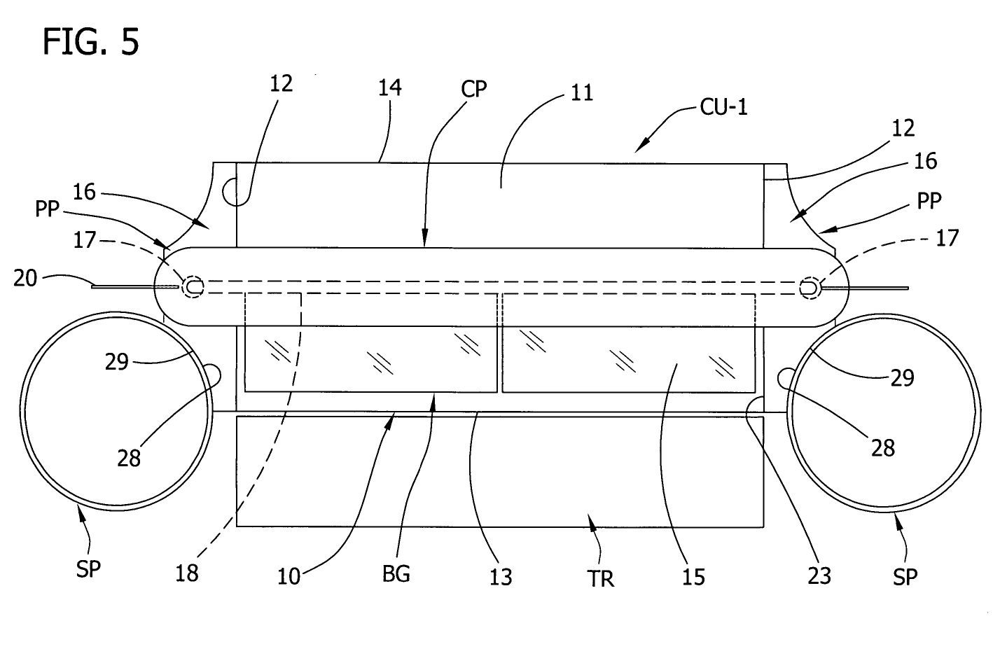

Referring now to FIGS. 3-5, one aspect of the invention is embodied in a food merchandising system FMS having single service counter unit CU-1 framed by a peripheral decor system comprised of two laterally spaced, flanking pylon peripherals PP spanned by a canopy peripheral CP vertically disposed over the counter unit. The counter unit CU-1 of this embodiment has a typical cabinet 10 structured with an upper countertop side 11 typically forming a primary foodservice zone, opposed outer end walls 12, a front serving side 13 (with a front decor panel DP) and a rear working side 14 that may access a typical under-counter area (not shown) for storage or the like. The counter unit CU-1 also has a tray rail TR defining a front edge of the serving area in front of the countertop 11, which also has a breath guard BG (i.e. “sneeze guard”) forming a transparent protective shield positioned over the countertop 11 so as to separate and shield the food dispensing area from the customer/consumer. In FIGS. 3-5, a solid countertop working zone 11 is shown, as used for several food purposes such as a pastry selection station, and the breath guard BG is shown with its transparent (glass) curtain 15 in a downward position as when a server is dispensing food products. The breath guard may be adjustable to at least one upper open position as for self service or to facilitate cleaning and maintenance.

In FIGS. 3-5, the pylon peripherals PP are constructed and arranged as secondary foodservice zones intimately associated with the counter and sides, and each includes a base section 16 which supports a vertically extending stanchion member or pole 17. In this embodiment, in which the pylons PP are juxtaposed proximate to each end wall 12 of the counter unit, the pylons PP may have a fixed spatial relationship that accommodates strategically mounting the breath guard BG in working orientation over the counter unit CU but independently thereof. Thus, a horizontal mounting rod 18 for the curved glass curtain 15 has its ends journaled in the vertical poles 17 of the pylons PP. It will be understood that the rod 18 may be extensible to accommodate variable spacing between the poles 17, and the mounting ends of the rod 18 may be constructed and arranged to permit rotation of the rod 18 to accommodate one or more different angular positions of the glass curtain 15 relative to the countertop 11. Reference may be had to co-assigned U.S. Pat. No. 6,561,317 disclosing an adjustable breath guard system conventionally attached to the upper work surface of the countertop, and that disclosure has been incorporated by reference herein in its entirety. Still referring to FIGS. 3-5, the upper end sections of the stanchion poles 17 may be constructed and arranged for two other functions; namely, to provide a means 19 for supporting the canopy peripheral CP above the counter unit CU, and to provide for additional decor or signage (i.e. mounting means 20, such as a flag, gonfalon, banner, sign or the like).

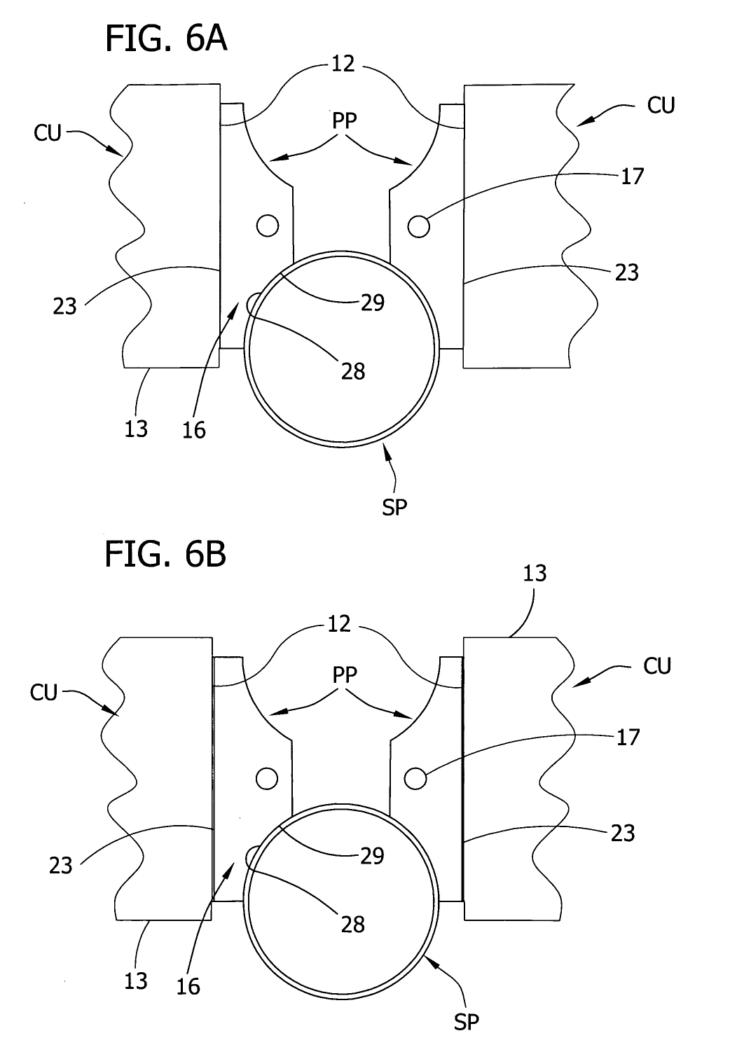

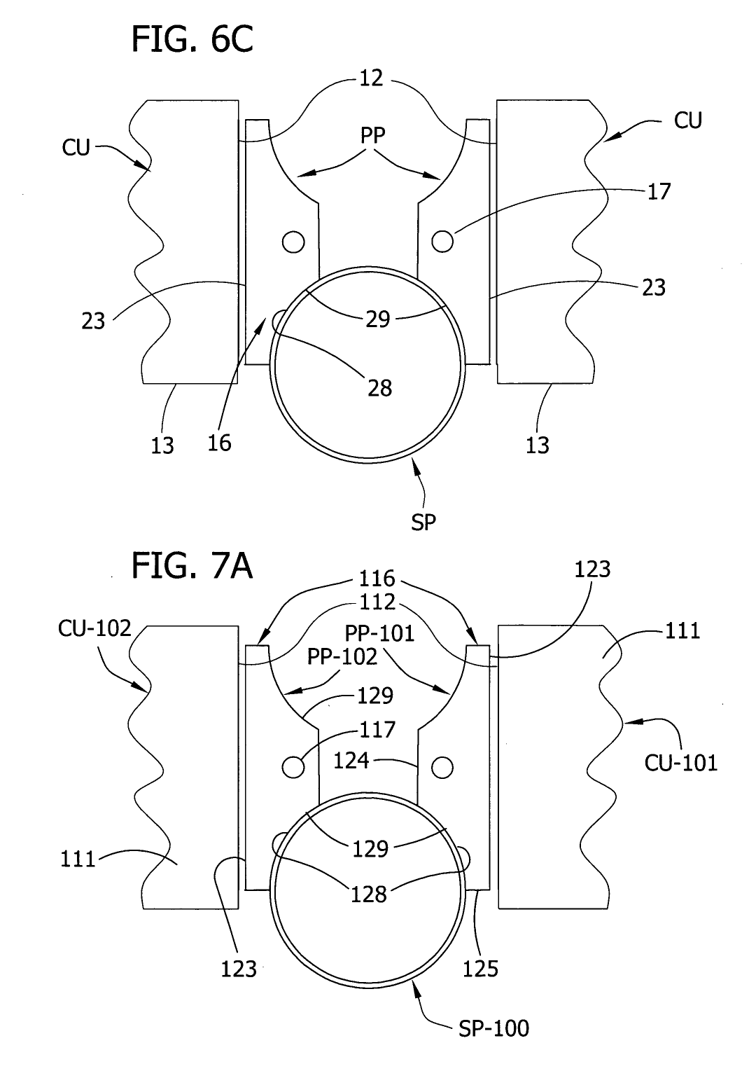

One aspect of the invention is to provide a food merchandiser for the display and dispensing or sale of food products and which, in addition to being highly functional, will be attractive and yet occupy a minimum floor space area to thereby enlarge the customer/consumer shopping and seating area. Thus, the end panels 12 of the primary counter unit (CU), and the opposed wall surface 23 of the pylon base section 16 are configured to be complementary and thus accommodate a matching fit when juxtaposed proximate to each other. In one form of this embodiment, the end panel margin (12) can be in abutting engagement (FIG. 6A) with the pylon wall 23 or so closely adjacent (or proximate to each other) as to appear to form a unitary unit and yet be structurally independent and have a sliding fit (FIG. 6B) therebetween, whereby the counter unit CU can be mounted on casters 22 and made mobile. In short, in one aspect the primary counter unit CU and secondary pylon peripheral PP can be unified and positioned in a fixed or permanent place in the food serving arena or, alternatively, they can be unified and made mobile together either for removal or repositioning in the food arena. A third alternative (FIG. 6C) is to make the counter unit mobile between fixed flanking pylons PP for replacement by another type of counter unit so as to provide food marketing flexibility either in types of food being served as in different seasons, or even to accommodate the food selection preferences of daily meals (i.e. hot breakfast items versus cold luncheon sandwiches).

Referring again to FIG. 2 and to FIGS. 3-5, another feature of the invention is to accommodate a food merchandising system having a line-up of multiple counter units (CU-1, CU-2, CU-3); it being understood that a single counter unit (FIG. 3) may embody the merchandising system of the invention (FIG. 3), or that two or more such single counter unit merchandisers may be arranged to form a substantially continuous food serving system (FIG. 2). As shown best in FIGS. 3-5, opposed surface areas (12, 23) of the counter (CU-1) and pylon (PP) are constructed and arranged to have the matching fit that accommodates unification (FIG. 6A), sliding fit (FIG. 6B) or the closely spaced relation (FIG. 6C) through which these two units are juxtaposed proximate to each other. The inventive feature accommodating a system line-up is provided through the pylon peripheral PP and its inner and outer wall configurations to closely join and unify the counter and shelving peripheral as a contiguous system. In FIGS. 2, 3 and 5 it will be seen that shelf peripherals SP have an outer surface wall or segment 28 that is complementary to at least one matching wall segment 29 of the pylon PP. In the embodiment of FIGS. 2-5, the first or inner wall 23 of the pylon is flat and opposes and matches the flat counter end 12. The pylon base 16 extends away from the counter (CU-1) and has transversely placed front and rear concave arcuate surfaces 29 to selectively match with the circular wall 28 of the shelf peripheral SP. Upper and lower shelves are shown to illustrate the display potential for food products, or for performing other related food-oriented functions. Thus, the circular shelf peripheral SP can be mounted on the pylon peripheral at either the front or back sides of the counter/pylon in a manner that positions the shelf rim 28 closely adjacent to the counter end 12 to optimize food service, but without being attached thereto.

As shown in FIG. 2, a series of counters can be strategically arranged in-line or at selected angularity to each other, as accommodated by joining opposite wall segments 28 of the shelf peripherals SP to adjacent arcuate segments 29 of the end-forming pylon peripherals PP of adjacent counters (i.e., CU-1 to CU-2).

Although not limiting on the scope of the invention, it will be noted in FIG. 2 that the counter CU-2 has a four-well hot food drop-in unit, and the counter CU-3 has a two-well unit. Each of these counters has a breath-guard BG carried by the dual counter-end pylon system of the invention. Thus, the pylon peripheral PP of the invention has a multi-function potential for structurally carrying the soffit peripheral CP, the shelving peripheral SP and mounting the breath guard BG to protect the food display countertop 11 of the counter unit (CU).

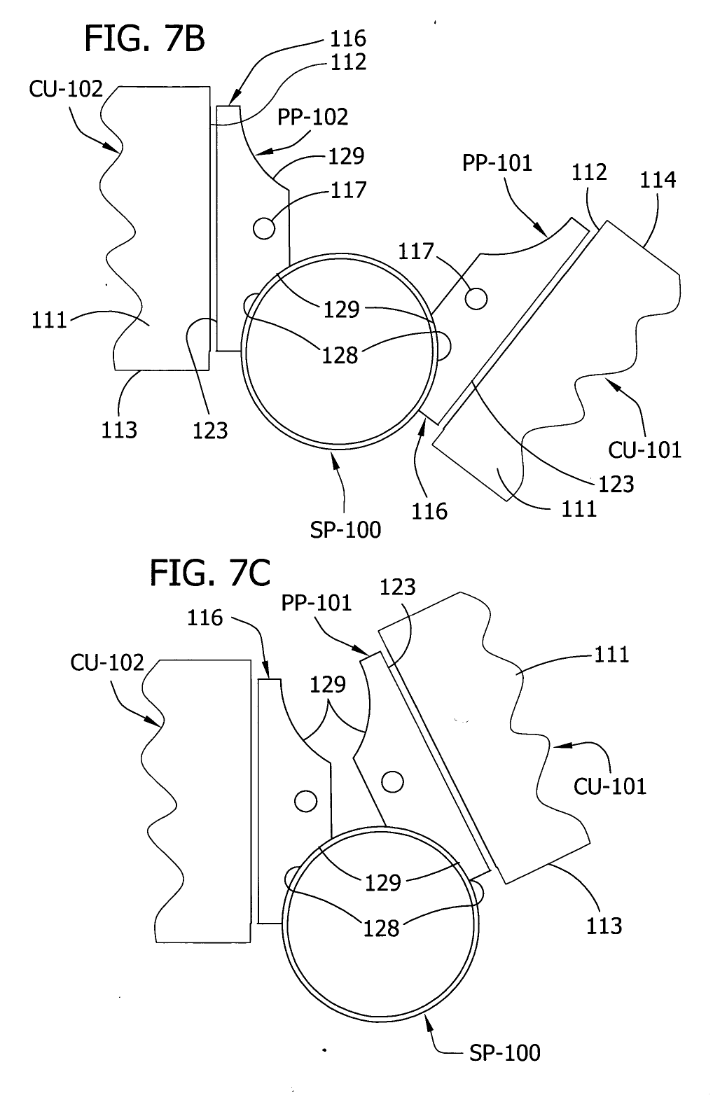

Another aspect of the invention is to provide a food serving or merchandising system in which a first counter end (12) and opposed pylon surface segment (23) are juxtaposed proximate to each other in such a relationship that a similar second counter end and pylon surface segment adjacent thereto can be joined together at varying angles through a connecting shelf peripheral (SP) or other food merchandising unit, see FIG. 2. FIGS. 7A, 7B and 7C illustrate one preferred embodiment of this counter end (12) to pylon surface segment (23) relationship. A counter CU-101 has a top surface 111 and a flat end surface 112 and its mating pylon PP-101 has an opposed flat wall segment 123 formed on base 116 opposite to the counter end 112 and being juxtaposed proximate thereto (in one of the unified relationships shown in FIGS. 6A or 6B or 6C). In short, the wall segment 123 of pylon PP-101 can be integral with the end wall 112 of counter CU-101 (FIG. 6A), or these walls can be abutting with a sliding fit (FIG. 6B), or they can be in closely spaced relation (FIG. 6C). FIGS. 7A, 7B and 7C also show that a similar counter CU-102 has a flat end surface 112 opposed by a mating inner surface segment 123 of pylon PP-102 that is juxtaposed proximate thereto. The pylons PP-101 and PP-102 of the adjacent counters CU-101 and CU-102 each have base sections 116 formed to support the vertical posts 117 (as in FIGS. 3-5), and the base sections have an outwardly facing configuration with a central wall segment 124 substantially parallel with the inner wall 128 and being connected to short end walls 125 by the concave arcuate wall surfaces 129. It is clear that these curved wall segments 129 are complementary to the outer wall 128 of the circular shelf peripheral SP-100, as previously discussed. Accordingly, the opposing pylon peripherals PP-101 and PP-102 are juxtaposed proximate to their respective counters and are connected by the circular shelf peripheral SP-100 to utilize substantially all of the space between the adjacent counter ends (112) without wasted floor space. The diameter of the circular shelf SP-100 can be varied according to the preselected display shelf area desired. FIG. 7A shows an in-line arrangement of the counters CU-101 and CU-102; FIG. 7B shows one angular positioning between these counters; and FIG. 7C shows a reversed angular position thereof—it being clear that this angular adjustability is accommodated by the universal or continuously complementary arcuate nature of the shelf peripheral wall against the oppositely facing pylons of the adjacent counters.

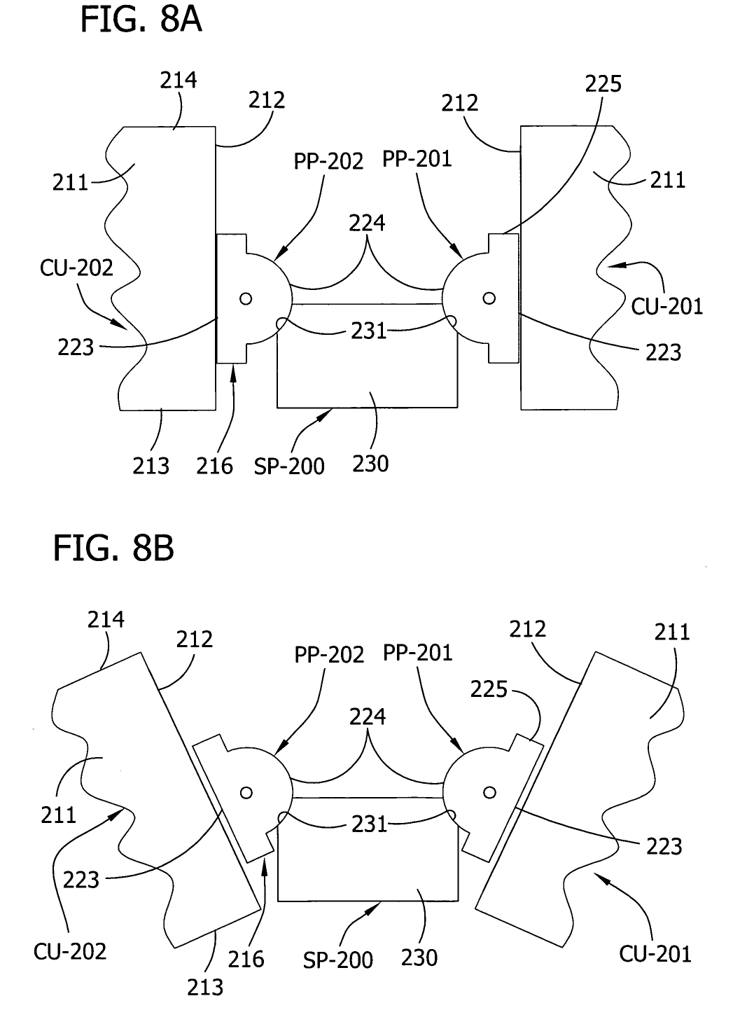

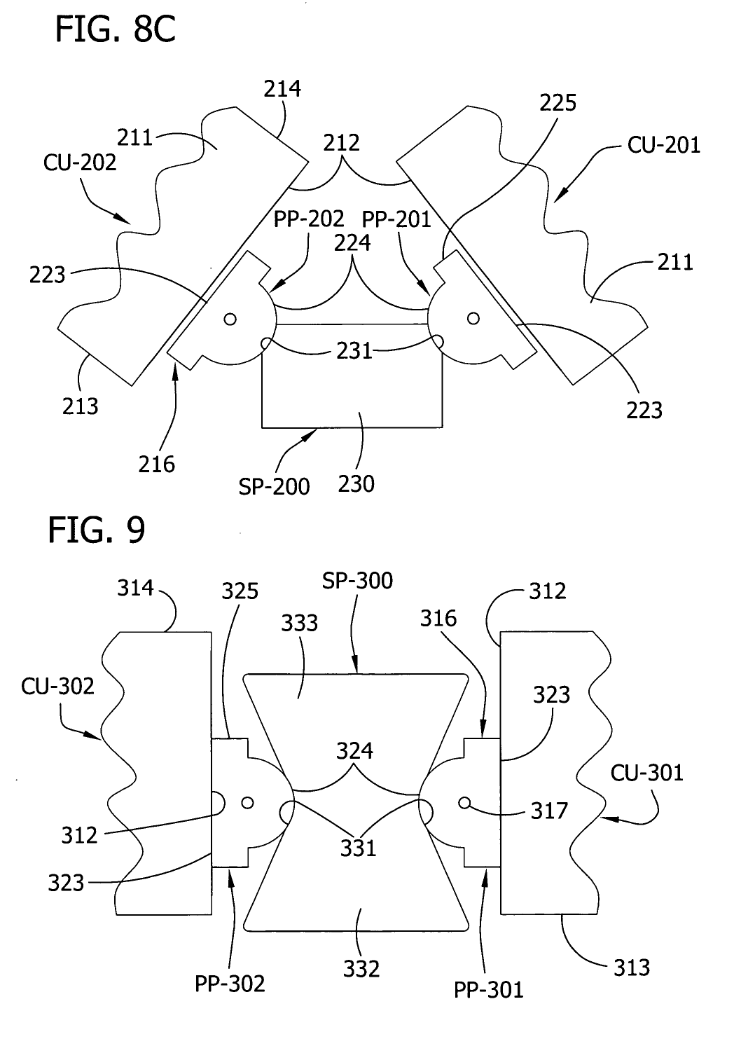

Referring to FIGS. 8A, 8B and 8C, another embodiment of the invention is illustrated with a modified configuration of the pylon peripherals PP-201 and PP-202 and shelving peripheral SP-200 for bridging between adjacent counter units CU-201 and CU-202. In this embodiment the pylon base 216 has an inner flat wall 223 opposed to and in juxtaposed proximity with the end wall 212 of the counter unit. It will be noted that the front-to-rear dimension of the pylon base wall 223 is substantially shorter than that of the counter end wall 212, which provides for selectively positioning the pylon along the counter end at or adjacent to the front panel 213, or toward the rear wall 214 or in the center of the counter unit. The pylon peripheral (PP-201; PP-202) in this embodiment has a convex (i.e. semi-spherical) outer wall segment 224 and end segments 225. The shelf peripheral SP-200 forms a tray or shelf 230 having concave wall segments 231 as at the rear corners, these segments being complementary to the convex curve of the pylon wall segment 224. Clearly, the length and depth of the shelving peripheral SP-200 will determine the food display area as well as the spacing between the adjacent opposed pylons and their respective counter units.

As in FIG. 7A, the FIG. 8A representation shows the counter units CU-201 and CU-202 in a straight end-to-end arrangement; and FIGS. 8B and 8C show the adjustable angularity between these counters in both frontward angled position (FIG. 8B) and a rearward angled position (FIG. 8C). Such adjustable or selective angularity is accommodated by the complementary wall segment curvatures of the convex pylon wall 224 and concave shelving wall 231.

FIG. 9 shows another modification of the invention in which the counter units CU-301 and CU-302 and their corresponding pylon peripherals PP-301 and PP-302 are similar to those shown in FIGS. 8A-8C. Thus the pylons have convex outer wall segments 324 to mate with concave arcuate wall segments 331 of a shelving peripheral SP-300, which is designed with both frontward and rearward tray areas (332; 333) and useful for food display in a double line cafeteria arrangement of counters. It will be seen that relative angularity between the counters CU-301 and CU-302 is still accommodated (as in FIGS. 8B and 8C).

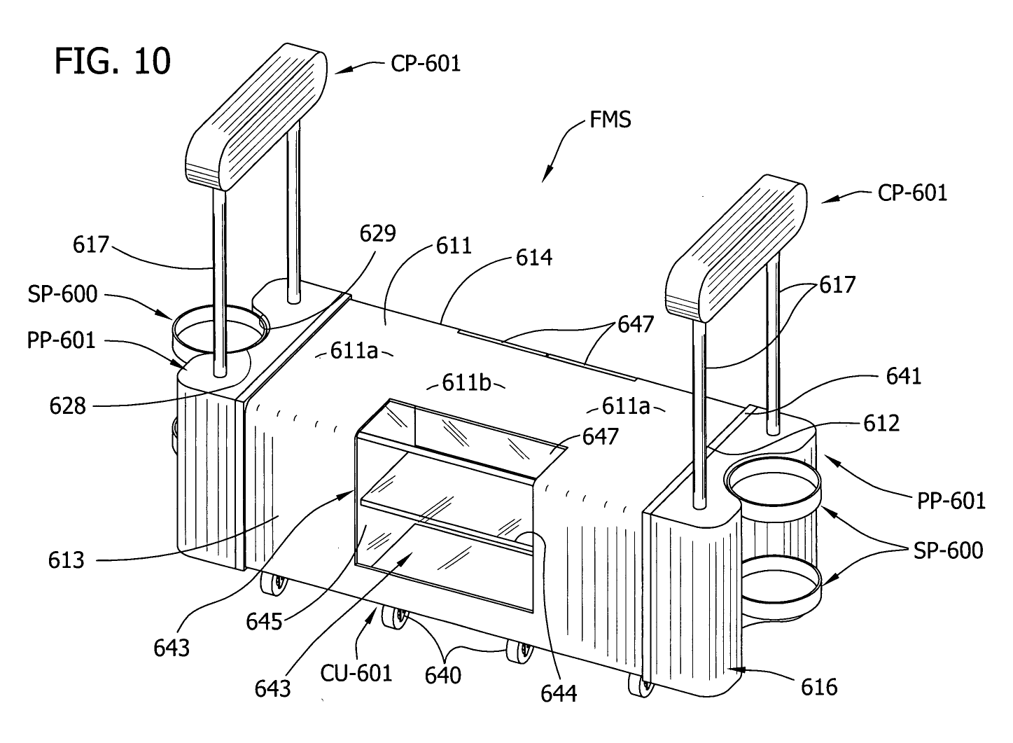

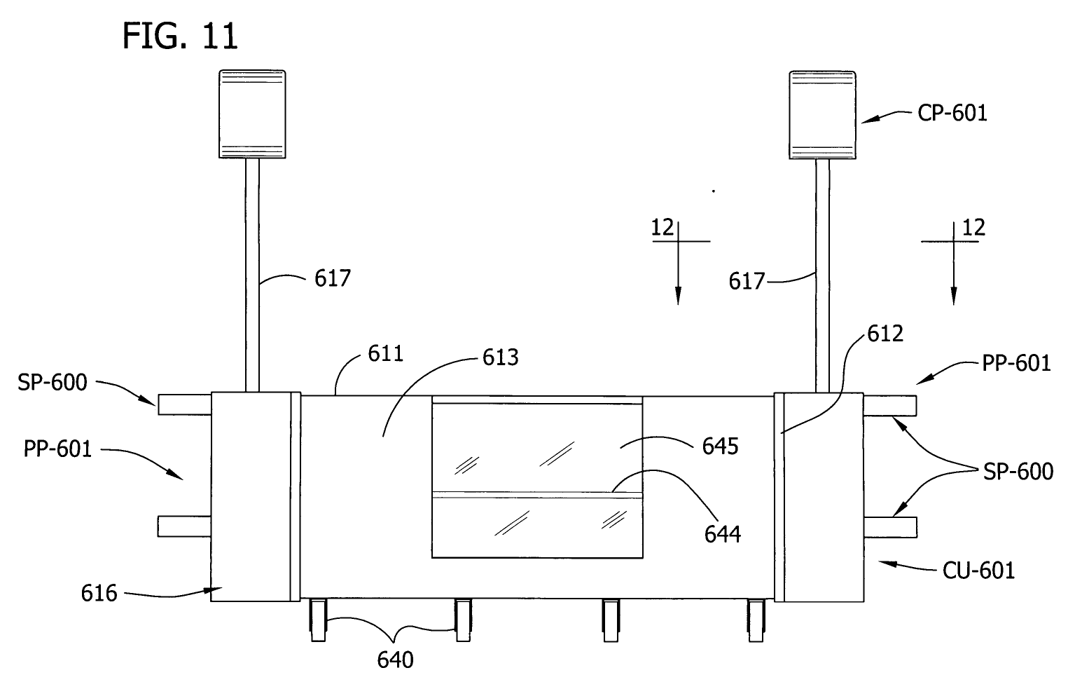

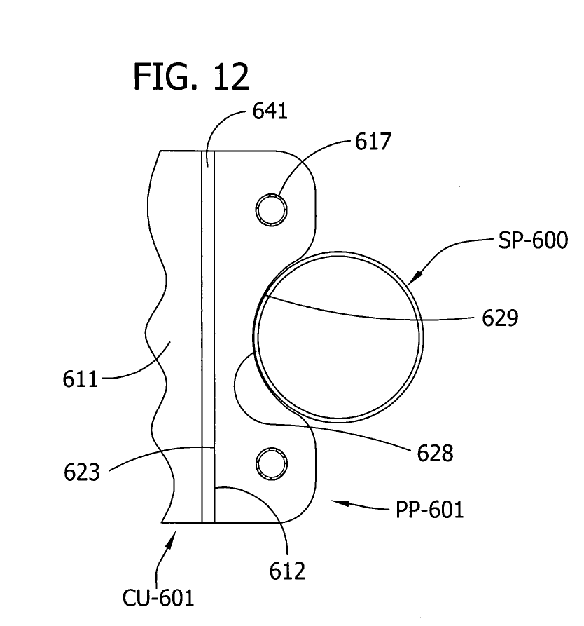

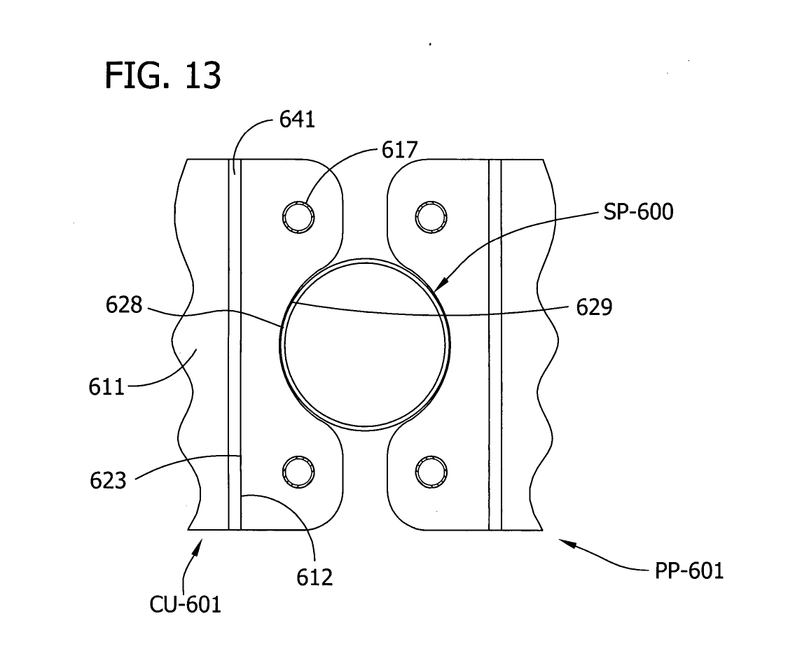

Referring now to FIGS. 10-13 showing another preferred embodiment of the food merchandising system invention FMS, a mobile food display and serving counter unit CU-601 is mounted on wheels 640 and includes a countertop side 611 (a, b), end panel sides 641 with outer flat walls 612, a front panel side 613 and a rear side 614. A feature of this embodiment is a closely associated secondary zone constructed and arranged to perform a separate food oriented or non-food function from that of the primary counter top side. In the FIG. 10-13 embodiment the associated secondary zone is a central food display zone 643 within the counter having interior shelves 644 that may be vertically adjustably mounted. These shelves 644 and food product (not shown) displayed thereon are enclosed by a large transparent front window 645 of glass in the front panel 613 and by a narrower transparent top window 646 of glass in the countertop 611 extending back from the front edge (613) of the counter to thereby provide an optimum vertically-angled sight line to the display products without requiring stooping or bending by the customer. The relatively narrow top window 646 affords good viewing of the interior shelving area without bending or squatting to better see through the front window, and at the same time provides for a maximum upper countertop work area in front (611b) of the vendor/serving person as well as on both outer sides (611a) thereof. The counter may have a rear wall 614 with rear doors or drawers 647 or the rear side (614) of the counter may be left open to access under-counter storage or for other purposes to be described with reference to another embodiment.

In addition another associated secondary zone includes the pylon peripherals PP-601 juxtaposed proximate to the end panel sides 641 and, in this embodiment, these are attached as unitary end caps to the end wall surface 612 whereby the pylon base 616 is above the floor and movable with the counter unit CU-601. The outer wall surface of the pylon PP-601 (i.e. outwardly facing away from the counter) is curvilinear with dual end cap portions 625 that transversely mount vertical posts 617, and a recessing concave central arcuate section 629 for supporting one or more shelf peripherals SP-600. A canopy peripheral CP-601 can be mounted on the dual endcap posts 617, or either front or rear soffits (not shown) can extend lengthwise across the counter between the end panels 641. Thus, in the FIG. 10-13 embodiment the countertop unit CU-601 has display shelving with the associated secondary zone of either the interior area 643 and/or the end panel peripheral PP-601.

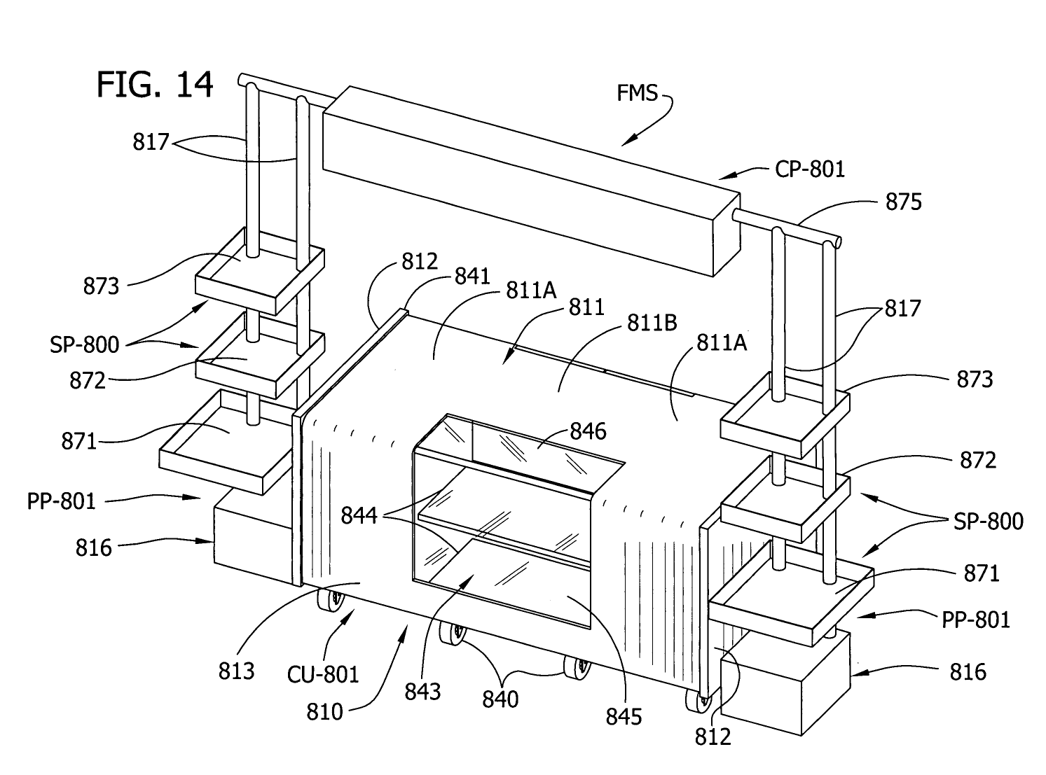

Referring to FIGS. 14-16, another embodiment of the mobile food display and serving unit CU-801 includes counter unit 810 having countertop 811 with outer end sections 811a and a bridging center section 811b therebetween, end panels 841 with outer end wall surfaces 812, front panel 813 and a rear side 814. The counter unit 810 is mounted on wheel units 840 for mobility. In this embodiment, the counter unit 810 is similar in most respects to the counter unit CU-601 of FIGS. 10-13. Thus, it has a central enterior food display zone 843 with adjustable shelves 844 and exteriorly enclosed by a transparent front window 845 in wall 813 and a narrow transparent top window 846 in the countertop 811. Again, as in the FIGS. 10-13 embodiment, the window arrangement 845, 846 provides optimum product visibility while maintaining a maximum countertop work area (811a, 811b).

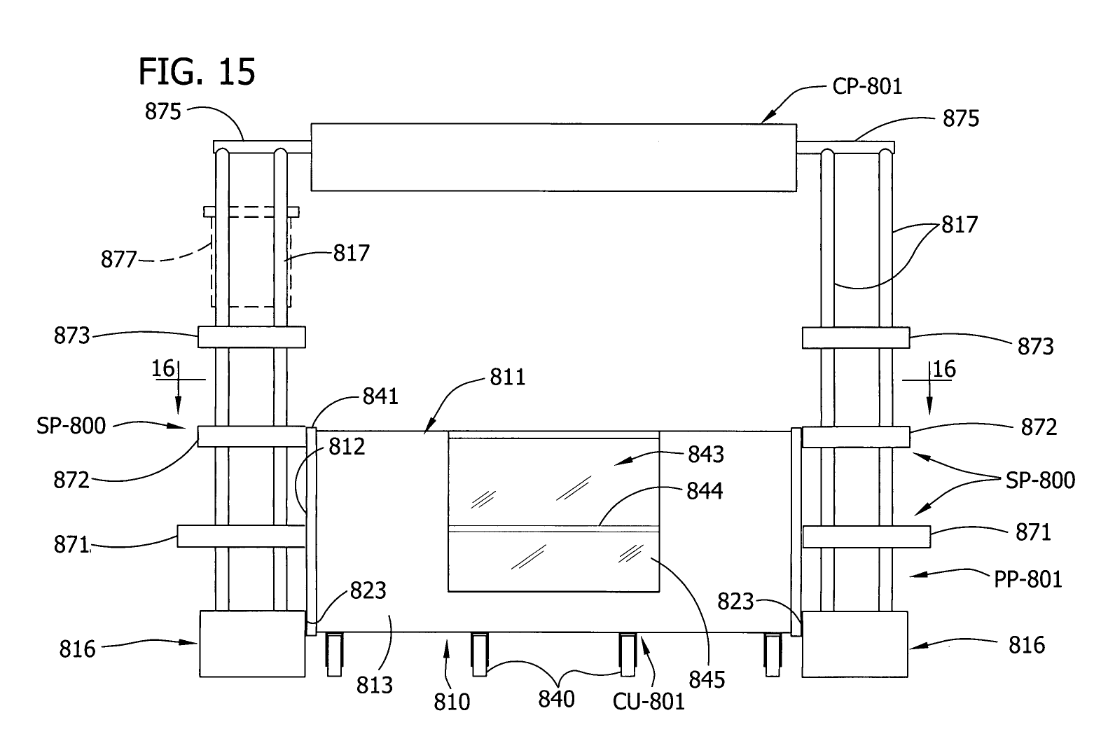

In the embodiment of FIGS. 14-16, the pylon peripherals PP-801 include a pylon base 816 that is floor-supported and juxtaposed proximate to the end wall surface 812 of the counter with its opposed wall surface 823. The pylon peripheral PP-801 also includes a double stanchion or dual post 817 mounted in the base 816 and extending upwardly therefrom, and being constructed to support one or more shelf peripherals SP-800. Multiple shelves may be of variable sizes as shown, with typically larger lower shelves 871 and smaller upper shelves 872, 873. It will be understood that the counter unit CU-801 is mobile on wheels 840 to move slidably between the floor-mounted pylon bases 816 and ascending shelving 871, 872, etc. The upper ends of the dual posts 817 are constructed to support an elongated canopy peripheral CP-801, as on mounting bars 875. These bars may be formed with a coupling unit (not shown) to permit relatively angular turning between the canopy and the dual pylon posts 817. The canopy can be used for signage, and/or lighting; the electrical therefor being accommodated through the hollow posts 817. In addition, optional signage or decor (877) as a flag, gonfalon, banner, sign etc. (FIG. 15).

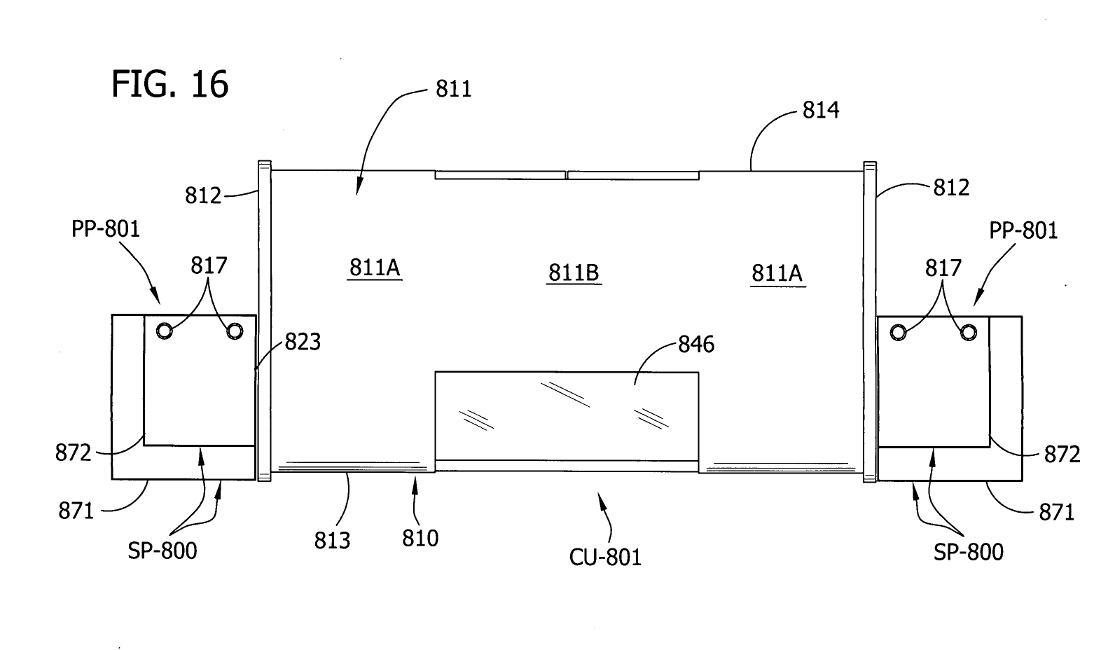

The mobile counters CU-601 (FIGS. 10-13) and CU-801 (FIGS. 14-16) are shown juxtaposed proximate to their respective pylon peripherals to thereby obtain optimum floor space usage. The mobile counter of these figures is also versatile in performing food-oriented functions. The central food display zone (643, 843) shows food product availability in a secure display setting having optimum visibility through the large front panel windows (645, 845) and smaller countertop windows (646, 846). The topside window (646, 846) not only enhances displayed food visibility, as shown best in FIG. 16, but is arranged to provide substantially continuous and ample countertop working surface area with large, unrestricted countertop end zones (811a) and an optimum central zone (811b) extending to the rear margin of the small window (846).

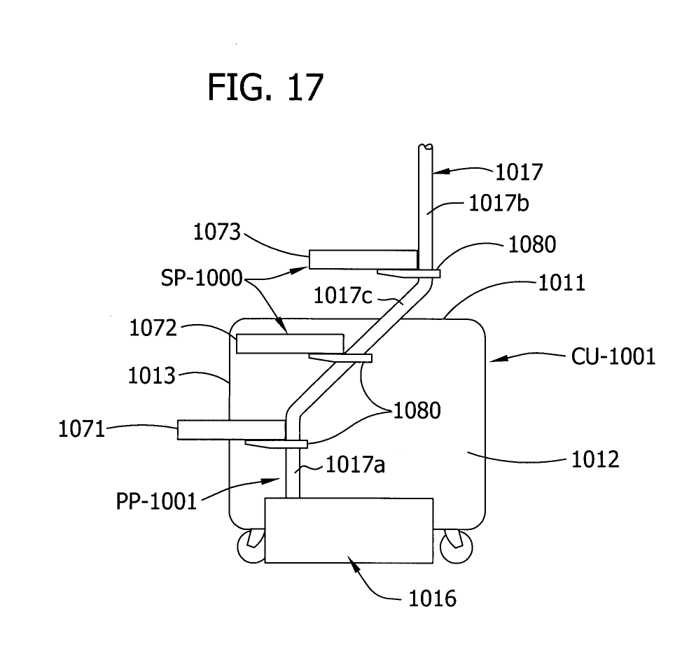

FIG. 17 shows another variation of pylon and shelving peripherals PP-1001 and SP-1000, in which the vertical post(s) 1017 of the pylon peripheral PP-1001 has vertical lower (1017a) and upper (1017b) sections offset transversely from each other and connected by an angularly extending intermediate section (1017c). The posts (1017) function to carry shelf support brackets 1080 at vertically spaced and transversely offset positions so that each ascending shelf 1071, 1072, 1073 will be recessed further from the front (1013) of the counter unit CP-1001 juxtaposed proximate thereto.

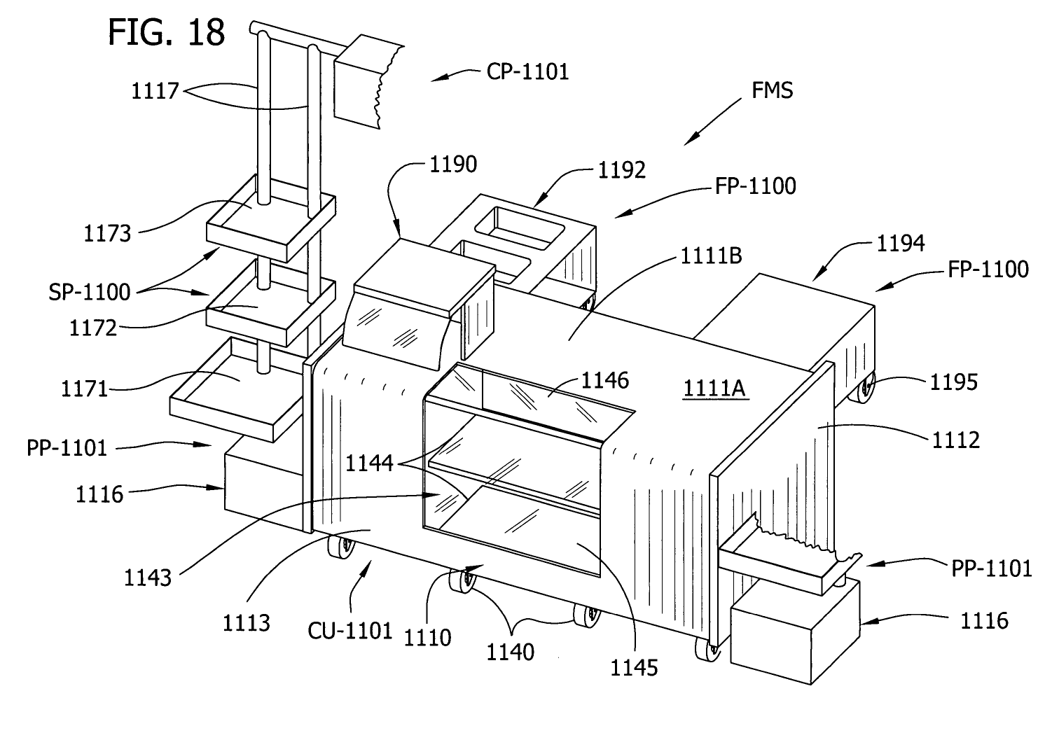

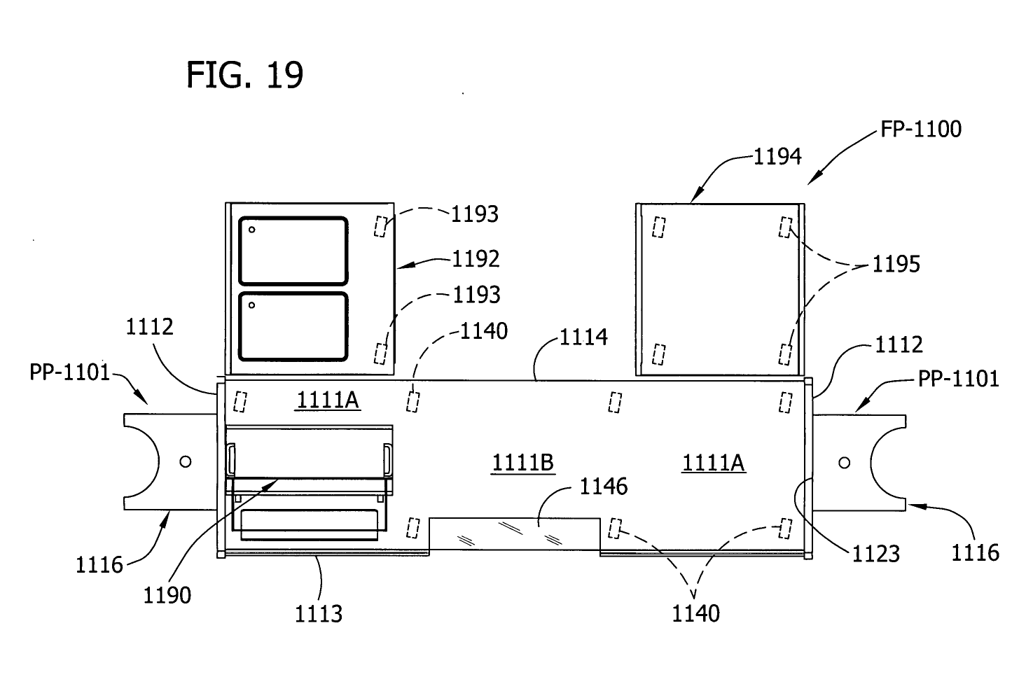

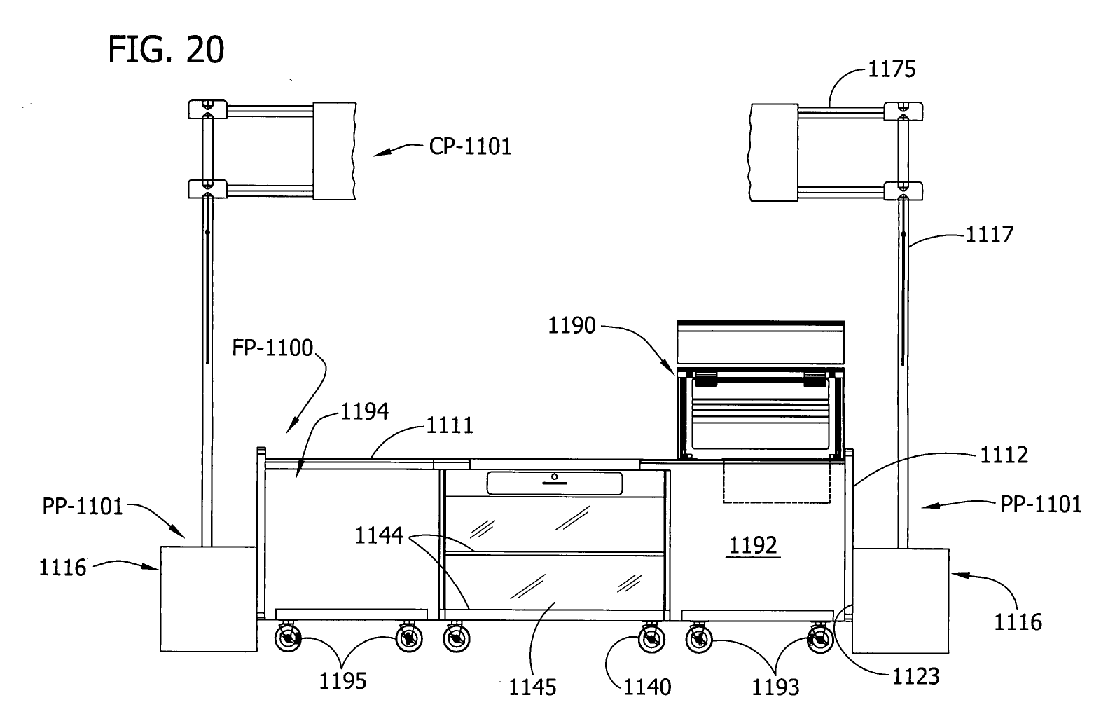

In FIGS. 18-20 a mobile food counter CU-1101 similar to the counters CU-601 (FIG. 10) and CU-801 (FIG. 14) illustrates the adaptability of this form of the invention as a versatile food display and serving merchandiser. FIG. 18 is taken from FIG. 14 with the reference numerals being changed to the “1100 series”. In addition, the soffit peripheral CP-1101 and right-hand pylon peripheral PP-1101 are broken away to better show counter adaptations.

Thus, it will be seen that the counter CU-1101 has the same large interior display shelf zone 1143 with adjustable shelving 1144 and high visibility through front window 1145 and topside window 1146, and the side zones of the counter below countertop sections 1111A afford large storage area capacity on each side of the central display zone 1143.

The versatility of this merchandiser CU-601 is further shown by representative counter adaptations that may include a countertop unit 1190, such as a single or multiple shelf selector case (with doors or without doors but having a sneeze guard). Preferably such a selector case 1190 would display ambient temperature food products, but a refrigeration unit could be placed in the under-countertop “storage” area to accommodate a cold selector case or self-contained heating or cooling countertop units may be placed on either side section 1111A. Another variation is to provide food-service peripherals FP-1100 with a food-service function in the form of one or two roll-up counter extension units, such as a hot multi-well unit 1192 mounted on casters 1193, and/or an auxiliary table-top unit 1194 mounted on casters 1195. Clearly all such units may be heated, refrigerated or at ambient, and it may be noted that at least one such unit (1194) may provide a non-food function such as holding a cash register (not shown). It is also clear that such food-service peripherals (FP-1100) could function as a shelving peripheral for the display and merchandising of food products. It will be understood that the mobile counter (CU-601, CU-801, CU-1101) is a novel and versatile food merchandiser either alone or in combination with pylon peripherals and/or shelf or soffit peripherals, as disclosed.

It will be apparent that a foodservice system incorporating a novel decor peripheral system and other unique features has been disclosed to meet the objectives and advantages set forth. The invention covers changes and modifications to the disclosure that will be apparent to those skilled in the foodservice art, and the invention is only to be limited by the scope of the appended claims.

1. A foodservice merchandiser comprising a counter unit having a cabinet with vertical front, rear and end sides and a horizontal upper surface countertop side extending between the upper margins of said vertical sides, said countertop side being constructed and arranged with a primary foodservice zone for performing a first food-oriented or non-foodservice function, and said cabinet also being constructed and arranged with a secondary foodservice zone for performing a second food-oriented or non-foodservice function, said secondary zone comprising shelving intimately associated at a selected one of the sides of the counter unit and being located interiorly or exteriorly of said cabinet.

2. The merchandiser of claim 1, in which said secondary foodservice zone is an interior zone with shelving within the cabinet behind the front side thereof, and window means in at least one of the cabinet sides for viewing the interior zone.

3. The merchandiser of claim 2, in which said window means is relatively large and is located in the vertical front side of the cabinet to extend downwardly from the upper margin thereof.

4. The merchandiser of claim 2, in which said window means is relatively narrow and is located in the horizontal countertop side to extend rearwardly from the upper margin of the front side of the cabinet.

5. The merchandiser of claim 2, in which said window means comprises a first vertical window extending downwardly from the upper margin of the front side of the cabinet, and a second horizontal window extending rearwardly in the countertop side from the front side of the cabinet.

6. The merchandiser of claim 5, in which the interior zone is a product display zone behind said front side and said first window is relatively large and exposes the entire front of said display zone to view, and said second window being relatively narrow and having only a limited sight line extending angularly downwardly into the display zone.

7. The merchandiser of claim 1, in which said countertop side has first and second end zones spaced apart by a connecting intermediate central zone and together being adapted to perform the first food-oriented function, and said secondary zone being associated with the intermediate central zone.

8. The merchandiser of claim 7, in which the shelving of said secondary zone is product display shelving constructed and arranged to occupy only a limited central portion of the cabinet associated with the central zone, and said window means including a first viewing window co-extensive with the width of the shelving in the interior secondary zone.

9. The merchandiser of claim 1, in which said secondary foodservice zone is an exterior zone with shelving extending outwardly in a direction away from one of the sides of the cabinet.

10. The merchandiser of claim 9, in which said secondary zone is a peripheral unit constructed and arranged adjacent to at least one end side of the cabinet.

11. The merchandiser of claim 10, in which said one end side and said peripheral unit are configured with complementary mating surface segments juxtaposed proximate to each other.

12. The merchandiser of claim 11, in which said cabinet is mobile, and said peripheral unit is attached to and supported by said cabinet so as to be mobile therewith.

13. The merchandiser of claim 11, in which said cabinet is mobile, and the mating surface segments of said peripheral unit and said one end side have a sliding fit to accommodate relative movement therebetween.

14. The merchandiser of claim 10, in which said peripheral unit comprises a base section constructed and arranged to form an end cap on said end side of the cabinet, and said shelving being attached to said end cap base section and projecting outwardly therefrom.

15. The merchandiser of claim 14, which includes a peripheral unit associated with each end side of the cabinet and being juxtaposed proximate thereto, and each of said peripheral units including a pylon unit extending vertically from the base section thereof, and other means carried by said pylon units for performing another food-oriented function.

16. The merchandiser of claim 15, in which said other means comprises a breath guard constructed and arranged to be supported by said pylon units and spanning at least a portion of the countertop side of the cabinet to shield that surface area thereof.

17. The merchandiser of claim 16, in which said breath guard has supporting end means journalled in the pylon units and constructed for relative angular movement of the breath guard above the countertop side surface.

18. The merchandiser of claim 15, in which said other means comprises soffit means carried by the pylon u nits and being superposed above a portion of the cabinet.

19. The merchandiser of claim 10 which includes, in combination, another similar merchandiser counter unit, said counter units being mobile and being arranged with adjacent end sides having their respective peripheral unit end caps closely adjacent to each other, and the shelving being constructed and arranged to bridge across between the end caps.

20. The merchandiser combination of claim 19, in which the shelving is constructed and arranged with the peripheral unit end caps for accommodating angular turning of at least one counter unit relative to the other counter unit.

21. A foodservice merchandiser, comprising a primary counter unit constructed and arranged for performing at least one direct or related food-oriented function, said primary counter unit having an upper countertop work surface with outer first and second end zones spaced apart by a bridging central zone and also having an interior display zone visible through a window associated with the central zone, and a peripheral unit constructed and arranged to perform another food-oriented function or a non-foodservice function and being configured with a vertical side segment at least partially complementary to the side wall configuration of at least a portion of one of said first and second end zones of said primary counter unit, said primary counter unit and peripheral unit being in juxtaposed proximity to optimize functionality with a minimum footprint in the food serving arena.
